(19) United States
(12) Patent Application Publication
(10) Pub. No.: US 2025/0200376 A1
(43) Pub. Date: Jun. 19, 2025

(54) SYSTEM FOR IMPLEMENTING A SPARSE CODING ALGORITHM

(71) Applicant: The Regents of the University of Michigan, Ann Arbor, MI (US)

(72) Inventors: Zhengya Zhang, Ann Arbor, MI (US); Thomas Chen, Ann Arbor, MI (US); Jung Kuk Kim, Santa Clara, CA (US); Phil Knag, Portland, OR (US)

(21) Appl. No.: 18/648,364

(22) Filed: Apr. 27, 2024

Related U.S. Application Data
(63) Continuation of application No. 15/176,910, filed on Jun. 8, 2016, now abandoned.
(60) Provisional application No. 62/172,527, filed on Jun. 8, 2015.

(51) Int. Cl. G06N 3/088; G06N 3/049; G06N 3/063

(52) U.S. Cl. CPC G06N 3/088; G06N 3/049; G06N 3/063

(57) ABSTRACT

A sparse coding system having a neural network including a plurality of neurons each having a respective feature associated therewith and each being configured to be electrically connected to every other neuron in the network and to a portion of an input dataset. The plurality of neurons are arranged in a plurality of neuron clusters each having a respective subset of the plurality of neurons, and the neurons in each cluster are electrically connected to one another in a bus structure, and the plurality of clusters are electrically connected together in a ring structure. Also provided is a sparse coding system that includes an inference module configured to extract features from an input image containing an object, wherein the inference module has an implementation of a sparse coding algorithm, and a classifier configured to classify the object in the input image based on the extracted features.

### GOVERNMENT LICENSE RIGHTS

This invention was made with government support under HR0011-13-2-0015 awarded by the Department of Defense/DARPA. The government has certain rights in the invention.

### TECHNICAL FIELD

The present disclosure relates generally to sparse coding algorithms, and more particularly, to a hardware architecture for implementing a sparse coding algorithm.

### BACKGROUND

A key component in many classification algorithms used in computer- or machine-based object or speech recognition/classification systems involves developing and identifying relevant features from raw data. For some raw data types, e.g., image pixels and audio amplitudes, there is often a set of features that more naturally describe the data than other features. Sparse feature coding/encoding helps reduce the search space of the classifiers by modeling high-dimensional data as a combination of only a few active features, and hence, can reduce the computation required for classification.

Sparse coding is a class of unsupervised learning algorithms that attempt to both learn and extract unknown features that exist within an input dataset under the assumption that any given input can be described by a sparse set of learned features. For example, a Sparsenet algorithm, which is an early sparse coding algorithm, attempts to find sparse linear codes for natural images by developing a complete family of features that are similar to those found in the primary visual cortex of primates. (“Features” are also known as “receptive fields,” and may be used herein interchangeably.) A sparse-set coding (SSC) algorithm forms efficient visual representations using a small number of active features. A locally competitive algorithm (LCA) implements sparse coding based on neuron-like elements that compete to represent the received input. A sparse and independent local network (SAILnet) algorithm implements sparse coding using biologically realistic rules involving only local updates, and has been demonstrated to learn the receptive fields or features that closely resemble those of the primary visual cortex simple cells.

Recently developed sparse coding algorithms are capable of extracting biologically relevant features through unsupervised learning, and to use inference to encode an input (e.g., image) using a sparse set of features. More particularly, the algorithm learns features through training a biologically-inspired network of computational elements or model neurons that mimic the activity of neurons of a mammalian brain (e.g., neurons of the visual cortex), and infers the sparse representation of the input using the most salient features. Inference based on the learned features enables the efficient encoding of the input and the detecting of features and/or objects thereof using, for example, a weighted sum of features of the model neurons (See FIG. 1). By keeping the activity of the model neurons sparse, the algorithm may produce a sparse representation of an input (e.g., input image) in a faster and more energy-efficient manner.

Implementation of an energy-efficient, high-throughput sparse coding algorithm on a single chip may be necessary and/or advantageous for low-power and real-time cognitive processing of images, videos, and audio in applications from, for example, mobile telephones or other like electronic devices to unmanned aerial vehicles (UAVs). Such an implementation is not without its challenges, however. For example, the number of on-chip interconnects and the amount of memory bandwidth required to support parallel operations of hundreds (or more) model neurons/computational elements are such that conventional hardware designs often resort to costly and slow off-chip memory and processing.

Accordingly, an objective of the present disclosure is to provide a hardware architecture that, in at least one embodiment, is contained on a single chip (e.g., an application specific integrated circuit (ASIC)) that implements a sparse coding algorithm for an application in learning and extracting features from, for example, images, videos, or audio inputs, and does so in a high-performance and low-power consumption manner. Such an architecture may have a number of applications, for example, emerging embedded vision applications ranging from personal mobile devices to micro unmanned aerial vehicles, to cite only a few possibilities; and may be used in image encoding, feature detection, and as a front end to a object recognition system. Other applications may include non-visual classification tasks such as speech recognition.

### SUMMARY

According to one embodiment, there is provided a sparse coding system. The system comprises a neural network including a plurality of neurons each having a respective feature associated therewith and each being configured to be electrically connected to every other neuron in the network and to a portion of an input dataset. The plurality of neurons are arranged in a plurality of neuron clusters each comprising a respective subset of the plurality of neurons, and the neurons in each cluster are electrically connected to one another in a bus structure, and the plurality of clusters are electrically connected together in a ring structure.

According to another embodiment, there is provided a sparse coding system. The system comprises an inference module configured to extract features from an input image containing an object, wherein the inference module comprises an implementation of a sparse coding algorithm. The system further comprises a classifier configured to classify the object in the input image based on the extracted features. In an embodiment, the inference module and classifier are integrated on a single chip.

### BRIEF DESCRIPTION OF DRAWINGS

Preferred exemplary embodiments will hereinafter be described in conjunction with the appended drawings, wherein like designations denote like elements, and wherein:

FIG. 1 is a schematic and diagrammatic illustration of an embodiment of a sparse coding architecture or system;

FIG. 2 is another schematic and diagrammatic illustration of an embodiment of a sparse coding system;

FIG. 3 illustrates an image (a) input to a sparse coding system such as, for example, the system illustrated in FIGS. 1 and/or 2, features learned by each neuron of the sparse coding system (b), and a reconstructed image (c) generated by the sparse coding system using a sparse code and the corresponding features;

FIG. 4 is a schematic and diagrammatic illustration of an embodiment wherein neurons of a neural network of a sparse coding system are fully connected to both each other and each pixel of at least a portion of an input image;

FIG. 5 illustrates feed-forward connections between the pixels of an input image and the neurons of a sparse coding system and weights associated with those connections, and feedback connections between neurons of the sparse coding system and weights associated with those connections;

FIG. 6 is a schematic diagram of a model of a neuron of a neural network of a sparse coding system;

FIG. 7 is a schematic and diagrammatic illustration of a neural network of a sparse coding system and depicts a model of a digital neuron thereof;

FIG. 8 is a schematic and diagrammatic illustration of a sparse coding system depicting a neural network thereof having a scalable multi-layer architecture;

FIG. 9 is a schematic and diagrammatic illustration of an embodiment of a neuron cluster of a neural network of a sparse coding system such as that illustrated in FIG. 8 wherein logic OR gates are used to connect certain neurons in the cluster together;

FIG. 10 is a graph illustrating the quantization of weights associated with neuron-to-neuron and neuron-to-pixel connections for a learning operation of a sparse coding system;

FIG. 11 is a graph illustrating the quantization of weights associated with neuron-to-neuron and neuron-to-pixel connections for an inference operation of a sparse coding system;

FIG. 12 is a diagrammatic illustration of a memory partitioned into a core memory to store the most significant bits (MSBs) of each weight associated with a neuron-to-pixel connection and each weight associated with a neuron-to-neuron connection, and an auxiliary memory to store the least significant bits (LSBs) of each weight associated with a neuron-to-pixel connection and each neuron-to-neuron connection;

FIG. 13 is a graph illustrating the effect of spike communication latency of a ring during an inference operation performed by an embodiment of a sparse coding system;

FIG. 14 is a diagram of an illustrative timing chart for an inference operation performed by a sparse coding system;

FIG. 15 is a microphotograph of a test chip used to test an embodiment of a sparse coding system;

FIGS. 16 and 17 are graphs illustrating results of testing the test chip illustrated in FIG. 15, and in particular, the measured inference power consumption (FIG. 16) and the measured learning power consumption (FIG. 17);

FIG. 18 is a table containing energy efficiency and performance metrics for the test chip illustrated in FIG. 15 determined during testing;

FIG. 19 is a graph and table illustrating a tradeoff between image reconstruction error and memory power consumption for an embodiment of a sparse coding system;

FIG. 20 is a schematic and diagrammatic illustration of an embodiment of an object recognition system comprising an inference module and a classifier;

FIG. 21 is another schematic and diagrammatic illustration of an embodiment of an object recognition system comprising an inference module and a classifier, wherein the inference module includes a plurality of neural networks and the classifier includes a plurality of sub-classifiers; and

FIG. 22 is microphotograph of the test chip used to test an embodiment of an object recognition system.

### DETAILED DESCRIPTION OF ILLUSTRATED EMBODIMENTS

In accordance with one aspect of the present disclosure, an architecture implementing a sparse coding algorithm is provided. More particularly, in an embodiment, the present disclosure relates to a sparse coding neural network implemented in a hardware architecture that may comprise a single-chip architecture (e.g., a “system-on-a-chip”) that includes on-chip learning for feature extraction and encoding. For purposes of illustration, the description below will be primarily with respect to the implementation of the sparse and independent local network (SAILnet) algorithm, and with respect to the use of the algorithm/architecture for visual object classification. It will be appreciated, however, that the same or similar architecture may be useful in implementing other sparse coding algorithms, for example, a locally competitive algorithm (LCA), and/or for applications other than visual object classification. As such, the present disclosure is not intended to be limited to any particular sparse coding algorithm(s) and/or application(s).

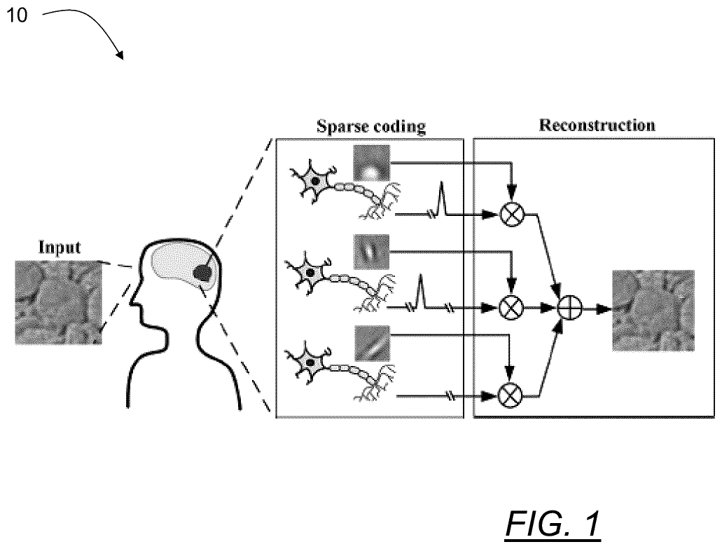

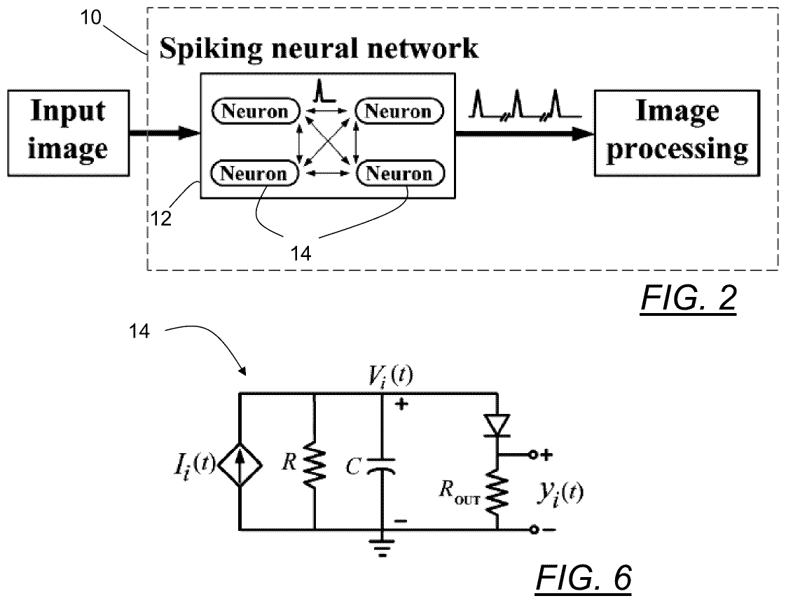

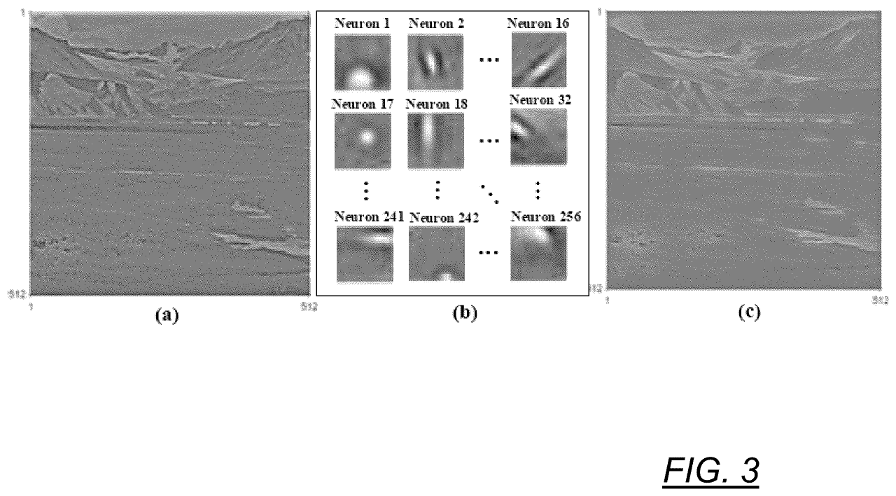

FIG. 1 depicts a conceptual illustration or representation of a biology-inspired sparse coding hardware architecture or system 10 embodied on a single chip (e.g., an ASIC) implementing, for example, the SAILnet sparse coding algorithm. In an embodiment such as that illustrated in FIG. 2, system 10 comprises a network 12 of model neurons or computational or computing elements 14 (hereinafter “neuron 14” or “neurons 14”). In operation, system 10 mimics the feature extraction performed by the primary visual cortex of a mammalian brain. As such, each neuron 14 develops a respective receptive field or feature that is associated therewith through unsupervised learning. As will be described in greater detail below, each neuron 14 may be activated to generate a binary output (i.e., logic “1”) referred to as a “spike” when the feature associated therewith is highly correlated with the input (e.g., input image). The spikes are kept very sparse through lateral inhibition of other neurons 14 in the network in response to the spiking of another one of the neurons in the network. The spikes constitute a sparse code that represents the input image. To check the quality of the sparse coding, the input image can be reconstructed using the resulting sparse code and the features or receptive fields corresponding thereto. For example, FIG. 3 shows a whitened input image (a), model neuron features learned by each neuron 14 (b), and a reconstructed image (c) corresponding to the input image that is generated using the sparse code and the corresponding features. The close resemblance of the reconstructed image to the input image demonstrates the effectiveness of the sparse coding algorithm.

More particularly, and as at least briefly described above, a sparse coding algorithm tries to find a sparse set of vectors known as receptive fields or features to represent an input dataset, for example and without limitation, an input image. The sparse coding algorithm is naturally mapped to the neuron network 12 of system 10, and one feature is associated with one neuron 14. The sparse coding hardware system 10 is capable of performing two primary operations: learning and inference. In the learning operation, the features associated with the neurons 14 are first initialized to random values, and through iterative stochastic gradient descent and using a plurality of training images, the algorithm converges to a dictionary of features that allows for an accurate representation of images similar to those used in the training/learning process using a small number of the learned dictionary elements. Learning is done in the beginning to set up weight values and occasionally afterwards to update the weights if the quality of a model of new input data modeled using the dictionary is unsatisfactory, so no real-time constraint is placed on learning.

However, inference needs to be done in real time. In inference, the algorithm generates neuron spikes to indicate the activated features from an input. Generally, the library size, or alternatively the number of neurons 14 needed by this algorithm, is no less than the number of pixels in the input image, as an over-complete library tends to capture more intrinsic features and the sparsity of model neuron activity improves with an over-complete library.

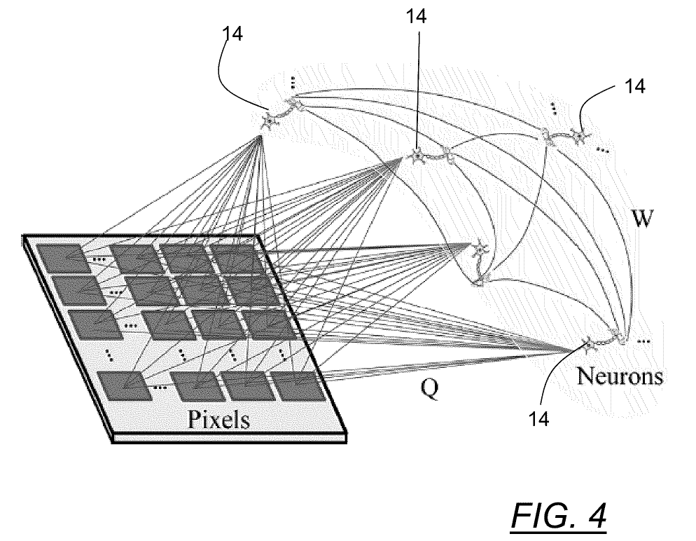

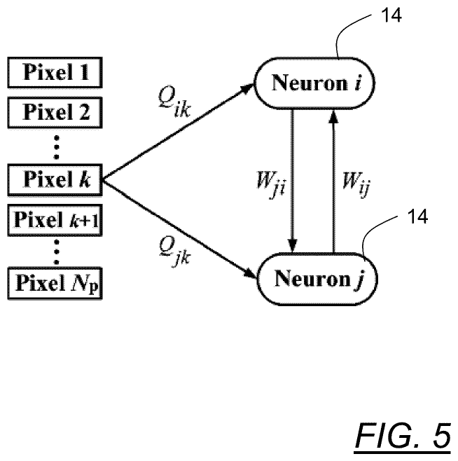

With reference to FIG. 4, in an embodiment, the neurons 14 of neural network 12 are fully connected to both each other and each pixel of an input image, or at least each pixel of a portion or patch of an input image, to implement the sparse coding algorithm. A weight is associated with each connection (i.e., neuron-to-neuron connection (feedback connection) and neuron-to-pixel connection (feed-forward connection)). As shown in FIG. 5, feed-forward connections between the neurons 14 and pixels of the input image are excitatory, and the associated weights are called Q weights. Conversely, the feedback connections between neurons 14 are inhibitory, and the associated weights are called W weights.

Neural network 12 develops the Q and W weights through learning. After learning converges, the Q weights of the feed-forward connections from a particular neuron 14 represent one feature in the dictionary. The W weights represent the strength of directional inhibitions between neurons 14, which allow neurons 14 to dampen the response of other neurons if their features are all highly correlated with each other. The lateral inhibition forces the neurons 14 to diversify and differentiate their features and minimizes the number of neurons 14 that are active at once.

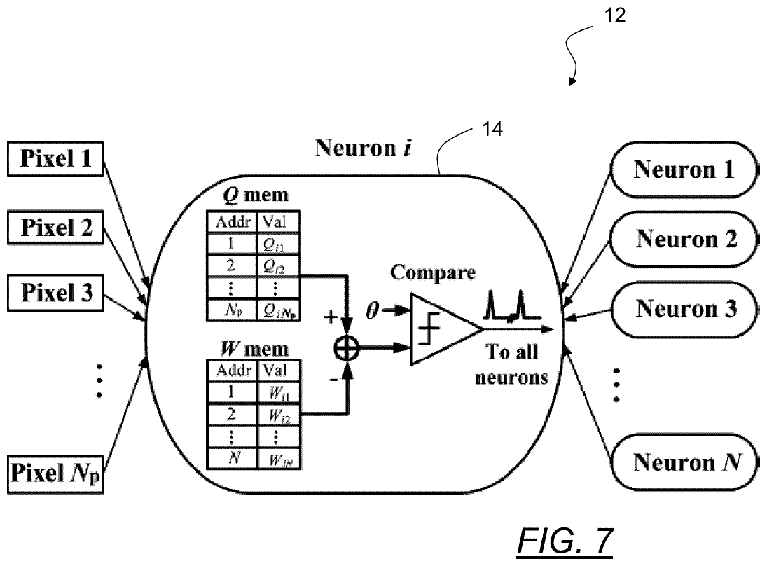

To illustrate the architecture and implementation of a sparse coding algorithm, the description below will be with respect to the SAILnet algorithm. In an embodiment, the SAILnet algorithm is based on, and thus the neurons 14 comprise, leaky integrate-and-fire neurons. A depiction of an illustrative model of a neuron 14 is shown in FIG. 6. In an embodiment, the model neuron 14 includes, in part, a current source Iᵢ(t) and a parallel RC circuit. The current source is determined by the inputs and activities of other neurons in the network 12 along with feed-forward and feedback connection weights. The current Iᵢ(t) is mathematically formulated as a continuous-time function shown in equation (1):

$${I}_{i} ( t ) = \frac{1}{R} ( {\sum }_{k = 1}^{{N}_{P}} {Q}_{ik} {X}_{k} - {\sum }_{j \neq i} {W}_{ij} {s}_{j} ( t ) ) , \qquad ( 1 )$$

where Xₖ denotes an input pixel value, sⱼ(t) represents the spike train generated by neuron j (i.e., sⱼ(t)=1 if neuron j fires at time t, otherwise, sⱼ(t)=0). As shown in FIG. 5, Qᵢₖ is the weight of the feed-forward connection between input pixel k and neuron i, and Wᵢⱼ is the weight of the feedback connection from neuron j to neuron i. Q is a N×N_{P} matrix that stores the feed-forward connection weights, wherein N_{P} is the number of pixels in the input image or particular patch thereof and N is the number of neurons 14 in network 12. Qᵢₖ stores the weight of the feed-forward connection between neuron i and pixel k. W is a N×N matrix that stores feedback connection weights, where again, N is the number of neurons 14 in network 12. Wᵢⱼ stores the weight of the feedback connection from neuron j to neuron i (directional). Equation (1) can be interpreted as that the input stimuli increase the current (an excitatory effect) and the neighboring neuron spikes decrease the current (an inhibitory effect).

Neuron voltage (i.e., voltage Vᵢ(t) across the capacitor C in FIG. 6) increases due to input excitation through the feed-forward connections and decreases due to lateral inhibitions and a constant leakage term proportional to the neuron voltage. The voltage represents a neuron's membrane potential. The resistor R in parallel with the capacitor C models the membrane resistance. When the current source Iᵢ (t) charges up the capacitor C and increases the membrane potential, some current leaks through resistor R. Equation (2) describes the leaky integration of the membrane potential:

$$C \frac{{dV}_{i} ( t )}{dt} = {I}_{i} ( t ) - \frac{{V}_{i ( t )}}{R} . \qquad ( 2 )$$

When the voltage of the neuron (i.e., Vᵢ(t)) exceeds a threshold voltage θ set by the diode illustrated FIG. 6, the neuron output yᵢ(t) emits a binary spike (i.e., a logic “1”) or spike train sᵢ(t) over time. After firing, the capacitor is discharged through a small resistor Rₒᵤₜ, i.e., Rₒᵤₜ<<R, to reset Vᵢ(t). Note, the network 12 described above uses binary spikes to communicate between neurons 14, which is different from non-spiking neural networks or a spiking neural network that relies on analog voltage or current as the way to facilitate communication between neurons. In any event, in an embodiment, the threshold voltage θ may be a learned parameter specific to each neuron, given by equation (3):

$${y}_{i} [ n ] = \{ \begin{matrix}1 ( and {V}_{i} [ n + 1 ] is reset to 0 ) , & if {V}_{i} [ n ] \geq θ \\ 0 , & if {V}_{i} [ n ] \leq θ\end{matrix} \qquad ( 3 )$$

The neuron activity within network 12 with respect to an input image is represented by the firing rate of the neurons 14. The synchronous digital description of a neuron's operation is given by the following equation (4):

$${V}_{i} [ n + 1 ] = {V}_{i} [ n ] + η ( {\sum }_{k = 1}^{{N}_{P}} {Q}_{ik} {X}_{k} - {\sum }_{j = 1 , j \neq i}^{N} {W}_{ij} {y}_{j} [ n ] - {V}_{i} [ n ] ) \qquad ( 4 )$$

where: Vᵢ is the voltage of neuron i; n is a time index; η is an update step size, N_{P} is the number of pixels in the input image or particular patch thereof; N is the number of neurons 14 in network 12; Xₖ is the value of pixel k in the input image, and yⱼ is the binary output of neuron j. Again, Q is a N×N_{P} matrix that stores the feed-forward connection weights, and Qᵢₖ stores the weight of the feed-forward connection between neuron i and pixel k; and W is a N×N matrix that stores feedback connection weights, and Wᵢⱼ stores the weight of the feedback connection from neuron j to neuron i (directional).

In an embodiment, Q weights, W weights, and the voltage threshold θ for each neuron 14 are learned parameters. In practice, a batch of training images are given as inputs to generate neuron spikes. The spike counts, sᵢ, where i is an index of the neuron, are then used in parameter updates. For example, using the SAILnet sparse coding algorithm, the updates may be calculated using equations (5)-(7):

$${Q}_{ik}^{( m + 1 )} = {Q}_{ik}^{( m )} + γ {s}_{i} ( {X}_{k} - {s}_{i} {Q}_{ik}^{( m )} ) \qquad ( 5 )$$

$${W}_{ij}^{( m + 1 )} = {W}_{ij}^{( m )} + β ( {s}_{i} {s}_{j} - {p}^{2} ) \qquad ( 6 )$$

$${θ}_{i}^{( m + 1 )} = {θ}_{i}^{( m )} + α ( {s}_{i} - p ) \qquad ( 7 )$$

where m is the update iteration number, and α, β, and γ are tuning parameters to adjust the learning speed and convergence, p is the target firing rate in units of number of spikes per input image per neuron used to adjust the sparsity of neuron spikes. An advantage of the learning rules for the SAILnet algorithm is their locality. Q and θ updates for any particular neuron only involve the spike count and firing threshold of that particular neuron, and W updates only involve the pair of neurons that are part of the relevant lateral connection. Note that the locality property of the SAILnet learning rules is a unique feature of the SAILnet algorithm, and it is not shared by all sparse coding algorithms.

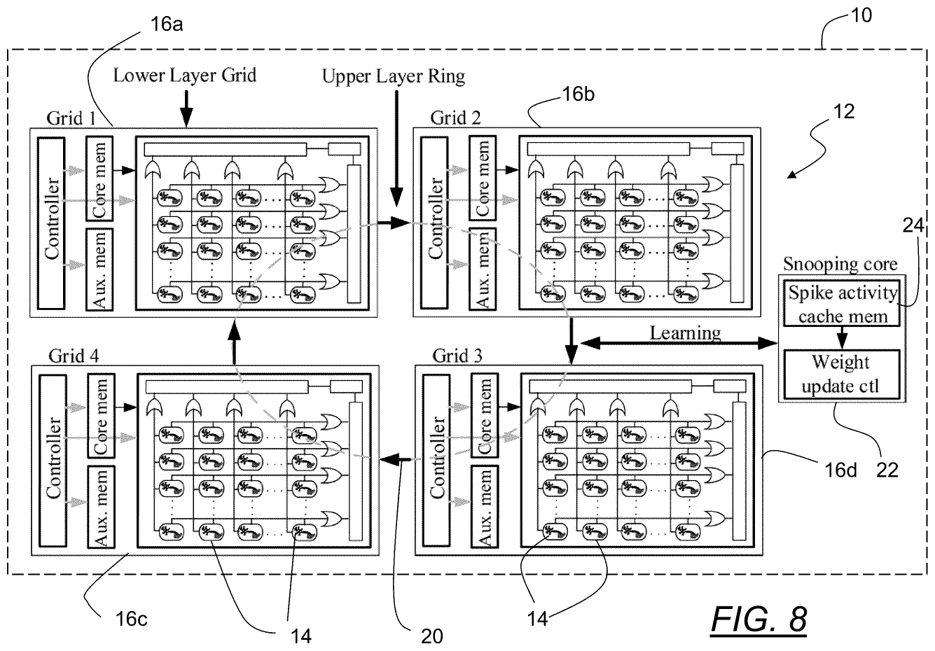

As discussed above, the SAILnet algorithm can be mapped to a fully connected neural network consisting of homogeneous neurons, and a binary spiking and discrete-time neuron model such as that described above makes it possible to design a simple digital neuron, such as, for example, that illustrated in FIG. 7. While it may be straightforward to parallelize the neurons in a neural network, the communication and interconnections or interconnects required for sharing the outputs of the neurons is a limiting factor to implementation on a single chip, as the routing in a direct implementation of a fully interconnected network may prove difficult, More particularly, to implement a sparse coding algorithm such as the SAILnet algorithm, low-latency communication for broadcasting a spike generated by one neuron to all other neurons in the network needs to be done for each inference step. Since each step is directly dependent on the previous step, significant delays in communication may alter the dynamics of the algorithm and worsen the quality of the subsequent encoding.

One way in which the neurons of a neural network may be connected together and communicate is through a bus structure. In a conventional bus structure, communication is advantageously a one-to-many broadcast, and the bus structure has low latency for small networks. However, a bus structure does not scale well with network size, and the high fan-out and wire loading of a bus structure may lead to relatively large RC delays. Larger neural networks also produce more spikes and thus bus structures may have a relative high spike collision probability. To account for this, spike collisions must be arbitrated with an arbiter, and, to serve many simultaneous spikes in a large network, the bus needs to run at a higher speed than the neurons, resulting in increased power consumption.

Another way in which neurons of a network may be connected together and communicate is through a ring structure. In conventional ring structures, the on-chip interconnects are all local, spikes generated by the neurons propagate serially, and spike collisions are eliminated. Since there are no spike collisions, no arbitration is needed, and fan-out in such structures is low, and the local wire capacitance does not grow with the network size. Therefore, a ring structure is highly scalable. However, the serial communication along a ring incurs high latency and may alter algorithm dynamics. Significant communication latency degrades image encoding quality and may yield unacceptable results.

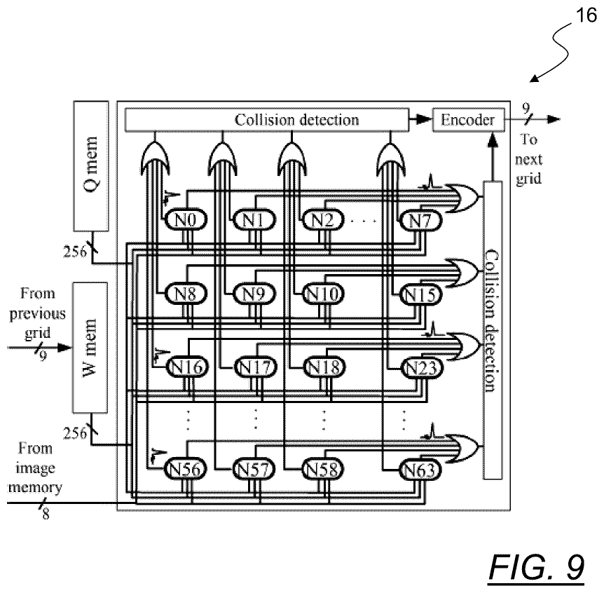

With reference to FIG. 8, in an exemplary embodiment of system 10, and network 12 thereof, in particular, rather than using only a bus structure or only a ring structure, a hybrid structure is employed to combine the unique advantages of both the bus and ring structures discussed above. More particularly, network 12 has a scalable multi-layer architecture, which, in an embodiment, comprises a two-layer architecture.

At a first or lower layer, the plurality neurons 14 of network 12 are grouped or divided into a plurality of different clusters 16 (i.e., 16a, 16b, 16c, etc.) with each cluster 16 containing a respective subset of the total number of neurons 14 in network 12, and the neurons 14 of each cluster 16 being connected together by a bus structure. As will be described below, the bus structure may comprise a single bus (e.g., flat bus) or may comprise a multi-dimensional (e.g., two-dimensional) bus or grid comprised of a plurality of buses. The number of neurons 14 in each cluster 16 (N₁)—and thus the size of the bus—may be chosen to keep the fan-out and wire loading of the bus structure low so that a low-latency broadcast bus structure can be achieved. A smaller number neurons and smaller bus size also keeps the spike collision probability low so that spike collisions can be discarded and arbitration removed with minimal to no impact on the image reconstruction error. In other words, the bus structure in this arrangement comprises an arbitration-free bus structure.

At a second or upper layer, a ring structure 20, for example, a systolic ring, is used to connect and facilitate communication between the plurality of clusters 16. The length of ring structure 20 (N₂)—and thus the number of clusters 16—is chosen to keep a low communication latency.

In an embodiment, the sizes of the first and second layers N₁, N₂ need to meet the requirement that N₁N₂=N, where N is the size of network 12 (or number of neurons 14 in network 12). There is a tradeoff between N₁ and N₂. A large N₁ and small N₂ increases the reconstruction error due to spike collisions, while a large N₂ and small N₁ increases communication latency. In an illustrative embodiment wherein network 12 includes or contains 256 neurons (i.e., N=256), it was found through empirical, software simulation that the tradeoff may be balanced when N₁=64 and N₂=4; in other words, when network 12 includes four (4) neuron clusters each containing 64 neurons.

In an embodiment, the bus structure of each cluster 16 is further optimized into a multi-dimensional bus structure or grid structure (e.g., an A×B grid structure comprised of A rows and B columns, wherein in an embodiment A=B), In at least some implementations, the grid structure comprises A horizontal buses each connecting B neurons in a row, and B vertical buses each connecting A neurons in a column. For example, in an embodiment, wherein network 12 includes 256 neurons that are grouped into four (4) clusters of 64 neurons each, the grid structure for one cluster may comprise an 8×8 grid structure having eight (8) horizontal buses each connecting eight (8) neurons in a row, and eight (8) vertical buses each connecting eight (8) neurons in a column. In any event, in an embodiment wherein each cluster 16 is arranged as a grid structure, the fan-out and wire loading seen by each neuron 14 may be substantially (e.g., quadratically) reduced compared to a flat bus structure. Even though there are more buses, the buses are shorter with fewer neurons connected to each bus. A shorter bus has a lower capacitance, and so the delay in transmitting spikes between neurons is shorter.

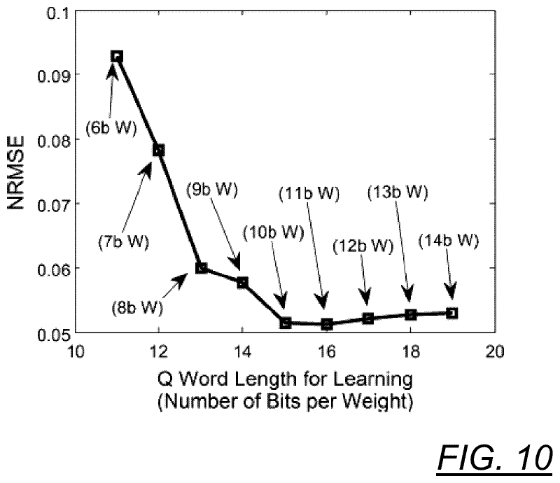

In another embodiment, rather than each grid being constructed of discrete buses, in an embodiment such as that illustrated in FIG. 9, each grid may be constructed of static combinational logic blocks wherein a logic OR gate is used to connect the neurons in a given column or row. For example, a grid may be implemented using a number of OR gates that is equal to the sum of the number of columns and rows in the grid, with each OR gate being associated with a respective column or row. By way of illustration, in an embodiment such as that described above wherein the grid structure comprises an 8×8 grid structure there may be sixteen (16) OR gates-eight (8) row OR gates and eight (8) column OR gates. The “OR” structure simplifies encoding of spikes generated by the neurons 14. A single spike is encoded using an address of the activated row and column together with an ID of the grid and a request bit, e.g., NID={[1-bit REQ] [2-bit grid ID] [3-bit row address] [3-bit column address]}. The grid also allows the detection of spike collisions. Multiple spikes will result in the activation of two or more rows and columns. Simple collision detection logic may be used to monitor the number of activated rows and columns. Since collisions are likely to occur only infrequently, due to the nature of the sparse coding algorithm, detected collisions are discarded with negligible loss in image reconstruction error. Removing collision arbitration required in, for example, bus-only structures, reduces the complexity and power consumption, and improves the throughput of the network.

In addition to the aforementioned complications relating to the interconnection of the neurons in a network, another complication is that the memory required to store Q weights grows at O(NₚN) and W weights grows at O(N₂), where, again, Nₚ is the number of pixels in the input image or at least a portion thereof, and N is the number of neurons 14 in the network 12. As a result, the memory costs significant area and power for a sufficiently large neural network. To account for this, the word length of the weights is optimized to reduce the memory storage and partition a memory device of system 10 into, for example, two (2) parts so that, during real-time inference, only one part of memory 18 is powered “on” to reduce power consumption.

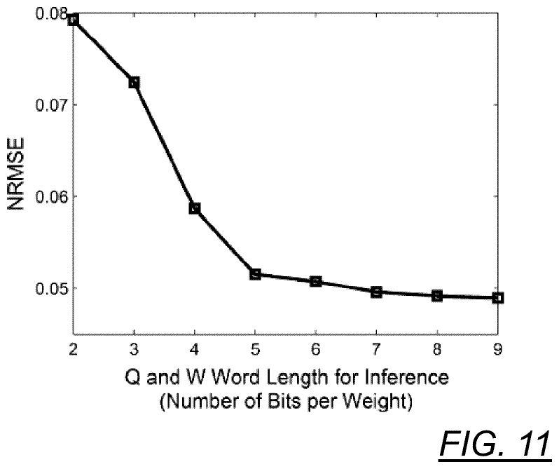

More particularly, in an embodiment wherein network 12 comprises 256 neurons, the network may require a 64 K-word Q memory to store Q weights and a 64 K-word W memory to store W weights. To reduce the word length, sparse coding algorithms can be quantized. For example, an empirical analysis of the fixed-point quantization effects on the image reconstruction error for the SAILnet algorithm was performed using software simulations. Given that the input pixels are quantized to 8-bits, results showed that the word length could be reduced to 13-bits per Q weight and 8-bits per W weight for a good performance, as shown in FIG. 10. Through testing using hardware-equivalent simulations, it was found that longer word lengths produced only marginal improvements.

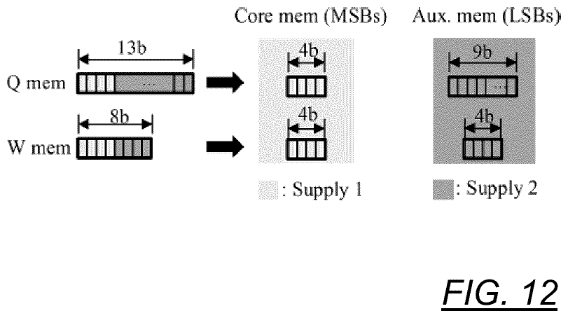

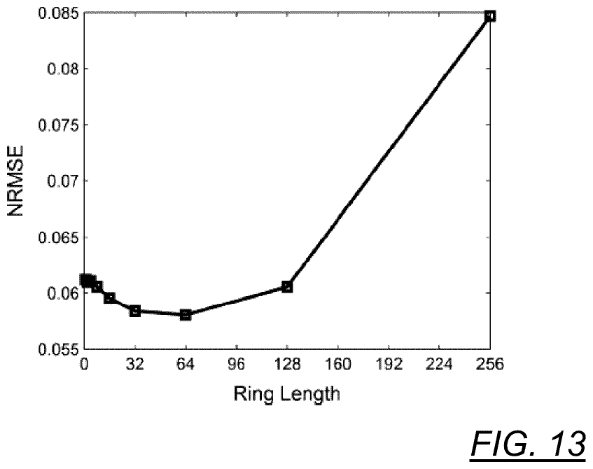

Through software simulations, it was also found that the word length required by learning and inference differ significantly for sparse coding algorithms. Learning requires a relatively long word length, e.g., for the particular implementation of the SAILnet algorithm, 13-bits per Q weight and 8-bits per W weight to allow for a small enough incremental weight update to ensure convergence, whereas the word length for inference can be reduced to 4-bits per Q weight and 4-bits per W weight for a good image reconstruction error, as shown in FIG. 11. To save power, the memory may be partitioned into a core memory to store the most significant bits (MSBs) of each Q weight and each W weight (e.g., 4-bit MSBs), and an auxiliary memory to store the least significant bits (LSBs) of each Q weight and W weight (e.g., 9-bit LSBs of each Q weight and 4-bit LSBs of each W weight) as shown in FIG. 12. In an embodiment, this partition results in a 512 kb main memory (256 kb to store Q weights and 256 kb to store W weights) and a 832 kb auxiliary memory (576 kb to store Q weights and 256 kb to store W weights). Once network 12 has been properly trained, the larger auxiliary memory is powered down.

The access bandwidth of the core and auxiliary memory also differ. The core memory is needed for both inference and learning. In every inference step, a neuron spike triggers the simultaneous core memory access by all neurons to the same address corresponding to the NID of the spike. Therefore, the core memory of all neurons in a local grid is consolidated to support the wide parallel memory access by all neurons.

The auxiliary memory is powered “on” only during learning. Since learning does not need to be in real time, it is implemented in a serial way. Moreover, approximate learning may be used to update weights and thresholds only for the most active neurons, so the fully parallel random access to the auxiliary memory is unnecessary. Hence, the auxiliary memory of all neurons in a local grid is consolidated into a larger address space to improve area utilization.

As described elsewhere above, network 12 may be used to perform an inference function, and as such, may be considered to be part of an inference module. More specifically, in illustrative embodiment, neurons 14 of network 12 (e.g., 256 neurons in the examples described above) are used to perform parallel leaky integrate and fire to generate spikes for inference. Inference is done over a number of inference steps nₛ, that is chosen based on the neuron time constant t and the inference step size n, i.e., nₛ=w/(ητ), where w is the inference period. For a low image reconstruction error, w is chosen to be sufficiently long, e.g., w=2—t, and the inference step size is chosen to be sufficiently small, e.g., n= 1/32 (in an instance wherein network 12 includes 256 neurons), resulting in the number of inferences steps being nₛ=64.

The leaky integrate and fire operation of neurons 14 described by equation (4) above has two main parts, excitation, Σₖ₌₁^{N}^{_{P}}QᵢₖXₖ, and inhibition, Σ_{j=1,j≠1}^{N}Wᵢⱼ [n]. Excitation computation is a vector dot product (e.g., for a 256-neuron network, 256 4-bit×8-bit multiplies in inference, 256 13-bit×8-bit multiplies in learning) and it results in a constant scalar being accumulated in every inference step, so excitation is computed first using a multiply-accumulate in each neuron.

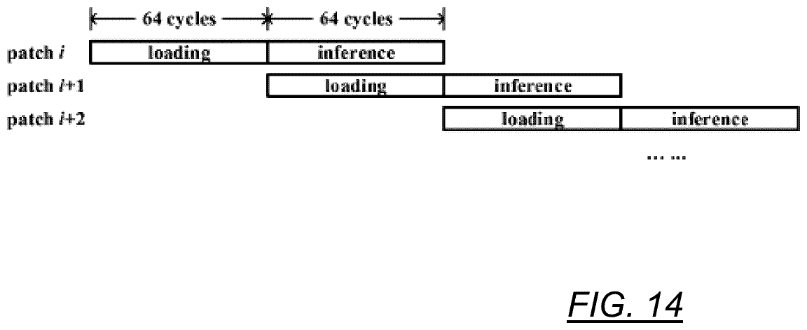

The inhibition computation is driven by spike events over the inference steps. Since the yᵢ[n] term in equation (4) is binary, the inhibition computation is implemented with an accumulator, requiring no multiplication. The inhibition computation is triggered by neuron spikes, i.e., after receiving a spike NID. In an embodiment, it may take up to (N₂−1) clock cycles (e.g., 3 clock cycles in an embodiment such as that described above wherein the ring comprises N₂=4 stages) for an NID to travel along an N₂-size ring to be received by every neuron 14, so a cycle-accurate implementation halts the inference for (N₂−1) cycles after an NID is transmitted. In this way, the inhibition computation over the 64-step inference described above requires up to 4×64=256 cycles, assuming one spike per inference step. To reduce the latency, the halt may be removed to implement approximate inference. In approximate inference, an NID will be received by neurons 14 in different grids/clusters 16 at different times, triggering inhibition computations at different times. Excessive spike latency may worsen the image encoding quality. However, since the latency is limited to (N₂−1) cycles, the fidelity is maintained as shown in FIG. 13. Using approximate inference, the inhibition computation over the 64-step inference requires exactly 64 cycles.

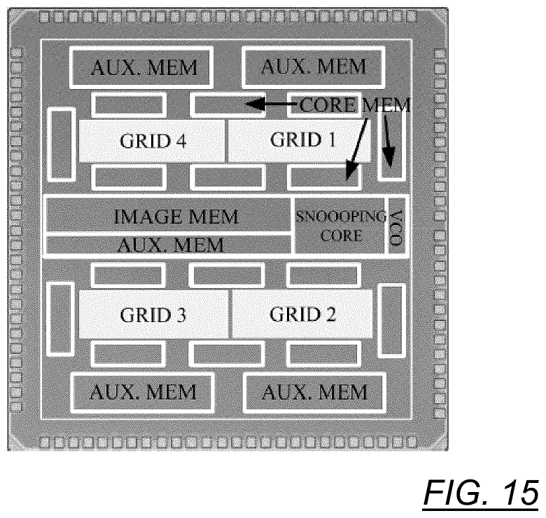

The inference operation of system 10 is divided into two phases: loading and inference. In an embodiment, loading for a 16×16 (pixel) still image may take 256 cycles and inference may take 64 cycles. In the case of streaming video, however, consecutive 16×16 frames may be well approximated by only updating a subset (e.g., 64) of the 256 pixels. Accordingly, each step may be done in 64 cycles, so that the two steps can be interleaved. FIG. 14 depicts an illustrative timing chart. In an embodiment, the pipelined processing enables the inference of a 16×16 image or image patch every 64 cycles, so the resulting throughput (TP)=(256f_{clk})/nₛ pixels, where folk is the clock frequency and nₛ=64.

With reference to FIG. 8, in an embodiment, the learning operation of the algorithm is implemented on system 10 with a snooping core 22 that is electrically coupled to the ring structure 20 to snoop spike events generated by one or more neurons 14 of network 12. To improve efficiency, parameter updates in learning are done in a batch fashion—spike events are accumulated in a cache for a batch of up to, for example, 50 training image patches, followed by batch parameter updates based on the recorded spike counts. Through software simulations, it was found that active spiking neurons, i.e., neurons with high spike counts, affect learning the most, and active spiking neurons also tend to spike early on. To take advantage of this discovery, a cache 24 is allocated to store the spike counts of the first batch of neurons to fire. The approximation reduces the cache memory size and the frequency of parameter updates in order to speed up learning. In an illustrative embodiment, the cache 24 may comprise a 10-word cache; though in other embodiments caches of other sizes may be used as it may be possible to improve the image reconstruction error even further with a larger cache.

Of the three types of parameter updates done in learning, Q, W, and θ, Q update is the most costly computationally, as it involves updating the Q weights of all feed-forward connections from the active spiking neurons. To simplify the control of parameter updates, a message-passing approach may be used. In the Q update phase, the snooping core 22 sends a Q update message for each of the most active neurons 14 recorded in the cache 24. The message may take the form of {[1-bit REQ] [8-bit NID] [4-bit SC]}, where REQ acts as a message valid signal and SC is the spike count. Messages are passed around the ring structure 20 and broadcasted through the grids/clusters 16. A small Q update logic is placed inside each grid/cluster 16 to calculate the Q weight update based on equation (5) above when the NID of the message belongs to the grid. The updated weight is saved in, for example, the 9-bit wide auxiliary memory. Occasional carry out bit from the update will result in an update of, for example, the 4-bit wide Q core memory. The Q updates in all of the grids/clusters 16 can execute in parallel to speed up the updates.

W weight update involves calculating the correlation of spike counts between pairs of the active spiking neurons. The snooping core 22 implements W update by generating a W update message for each active spiking neuron pair. The W update message may be in the form of {[1-bit REQ] [8-bit NID₁] [8-bit NID₂] [4-bit SC₁] [4-bit SC₂]}, where NID₁ and NID₂ are the pair of active spiking neurons, and SC₁ and SC₂ are the respective spike counts. A small W update logic in the snooping core 22 calculates the W weight update based on equation (6) above. The updated weight is saved in, for example, the 4-bit wide W auxiliary memory, and the carry out bit is written to the 4-bit wide W core memory. Similarly, θ update is implemented by passing a θ update message in the form of {[1-bit REQ] [8-bit NID] [4-bit SC]}. θ updates are done by the respective neurons in parallel.

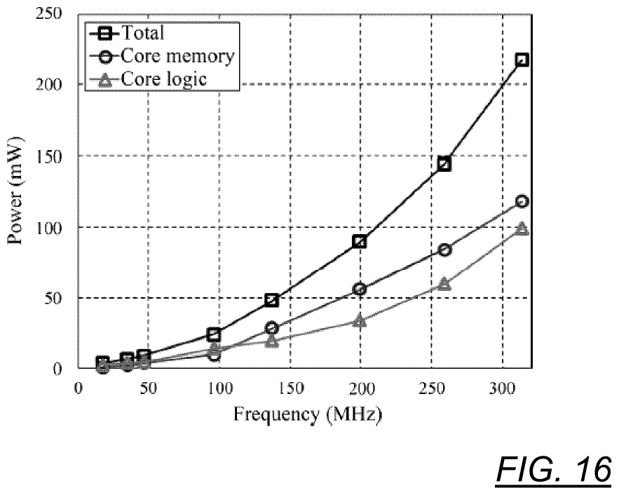

To demonstrate the operation and functionality of system 10, the architectural and algorithmic features described above were incorporated in an ASIC test chip implemented in TSMC 65 nm CMOS technology. FIG. 15 depicts a microphotograph of the test chip with certain parts of the design highlighted. The test chip has four separate power rails for four macro blocks: core logic (including neurons, grid and ring logic, and snooping core), 512 kb core memory implemented in sixteen (16) 256b×128b register files, and 832 kb auxiliary memory implemented in four (4) 2048b×72b SRAM to store Q weights and a 2048b×128b SRAM to store W weights, and a voltage-controlled oscillator as the clock source.

The test chip was limited in the number of input and output pads, therefore the input image was scanned bit-by-bit into the SRAM. After the scan was complete, the chip operated at its full speed. It is envisaged that this ASIC chip would be integrated with an imager so that the image input can be provided directly on-chip, and not limited by expensive off-chip input and output.

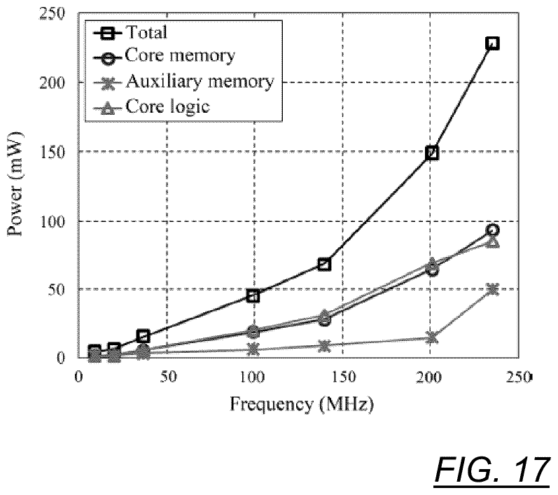

Bench testing of the hardware prototype demonstrated that the test chip was fully functional. The measured inference power consumption is plotted in FIG. 16, where each point in the plot corresponds to the power consumption at the lowest supply voltage at the given clock frequency. The auxiliary memory is powered down in inference to save power. At room temperature and 1.0V core logic and core memory supply, the test chip was measured to operate at a maximum clock frequency of 310 MHz for inference, consuming 218 mW of power. At 310 MHz, the chip was measured to perform inference at 1.24 Gpixel/s (Gpx/s) at 176 pJ/pixel (pJ/px). At 35 MHz and a reduced throughput of 140 Mpx/s, the core logic voltage supply could be scaled to 530 mV and core memory voltage supply could be scaled to 440 mV. The voltage supply and frequency scaling reduced the power consumption to 6.67 mW and improved the energy efficiency to 47.6 pJ/px.

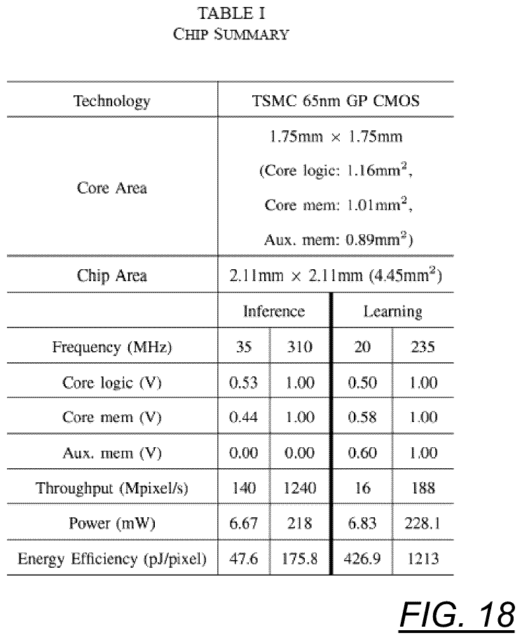

The measured learning power is shown in FIG. 17. Similarly, each point corresponds to the power at the lowest voltage at the given frequency. The auxiliary memory is powered on in learning. At room temperature and 1.0V core logic, core memory, and auxiliary memory supply, the test chip was measured to achieve a maximum clock frequency of 235 MHz for learning, consuming 228 mW. At 235 MHz, the test chip was measured to process training images at 188 Mpx/s. A large training set of 1 million 16×16 pixel image patches could be processed in 1.4 s. Learning requires writing to memories, which requires a minimum supply of 580 mV for the core memory and 600 mV for the auxiliary memory. At the minimum supplies, the learning power consumption was reduced to 6.83 mW at 20 MHz. The energy efficiency and performance metrics measured during the testing of the hardware prototype are summarized in the table set forth in FIG. 18.

It will be appreciated that values of the performance characteristics and parameters set forth above comprise test data relating to the specific implementation of the test chip. Because one or more of the performance characteristics and parameter values may differ depending on the particular implementation of the chip, it will be further appreciated that the present disclosure is not intended to be limited to any particular values for the performance characteristics/parameters.

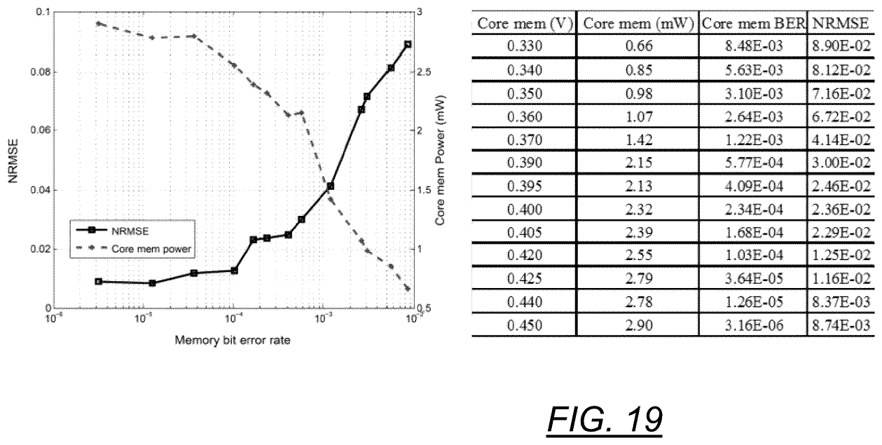

An interesting aspect of sparse coding algorithms is their resilience to errors in the stored memory weights. This resilience stems from the inherent redundancy of the neural network and the ability to correct errors through on-line learning. The benefit of this error tolerance was explored by looking at supply voltage over-scaling of the core memory in inference for potential energy savings to exploit the potential trade-off possible with this system. To do so, memory bit error was measured using the scan chain interface to first write and verify the correct known values at the nominal 1.0V supply voltage, and then lower the supply voltage, run inference, and read out the values for comparison. FIG. 19 shows the increase of the NRMSE and the reduction of memory power dissipation at supply voltages down to 330 mV and memory bit error rate up to about 10-2. The NRMSE curve is relatively flat up to bit error rate of 10-4. The rapid increase of NRMSE occurs when bit error rate is above 10-3. The error tolerance measurements highlight the potential for use of low-power unreliable memory elements in the implementation of sparse coding ASICs.

In any event, in an illustrative embodiment, system 10 comprises a 256-neuron architecture or system for sparse coding. A two-layer network is provided to link four (4) 64-neuron grids/clusters in a ring to balance capacitive loading and communication latency. The sparse neuron spikes and the relatively small grid keep the spike collision probability low enough that collisions are discarded with only slight effect on the image reconstruction error. To reduce memory area and power, a memory is provided that is partitioned or divided into a core memory and an auxiliary memory that is powered down during inference to save power. The parallel neural network 12 permits a high inference throughput. Parameter updates in learning are serialized to save the implementation overhead, and the number of updates is reduced by an approximate approach that considers only the most active neurons. A message passing mechanism is used to run parameter updates without costly controls.

In an embodiment, the functionality and operation of system 10 that has thus far been described may comprise a sparse feature extraction inference module (IM) that may be integrated with a classifier 26 (e.g., a task-driven dictionary classifier) to form a object recognition processor. In other words, the IM may comprise a front end and the classifier a back end to an end-to-end object recognition processor disposed on a single chip. Accordingly, in an embodiment, system 10 may further include a classifier for performing an object classification/recognition function in addition to the components described above.

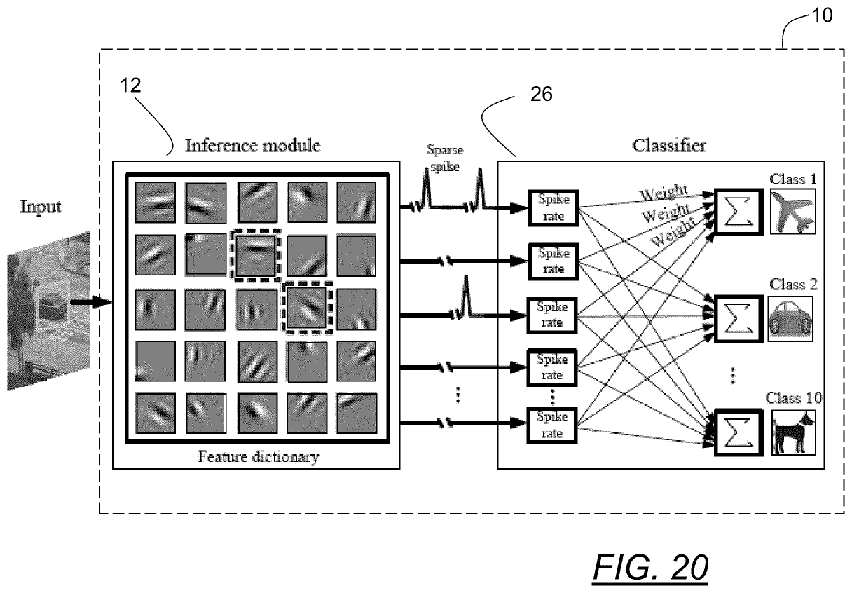

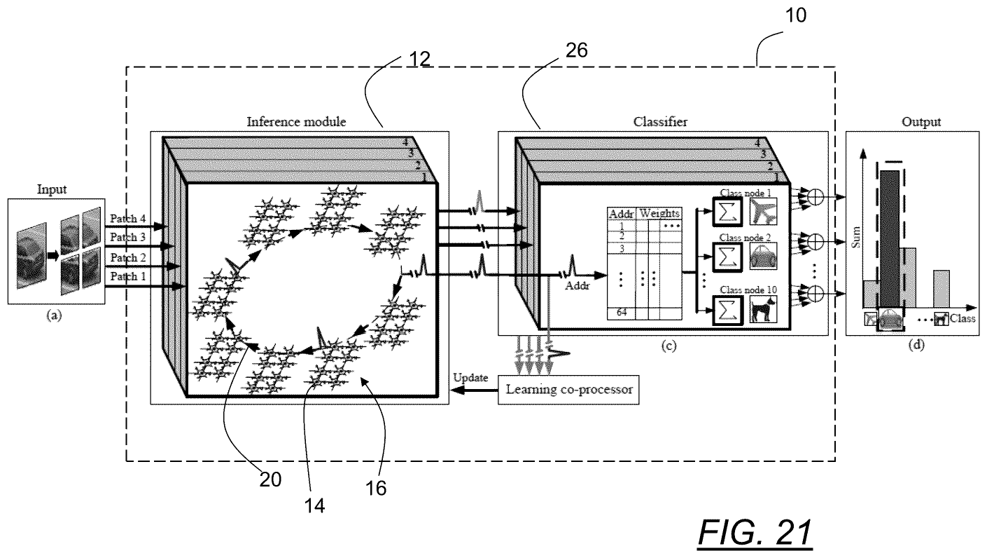

As at least briefly described above and as illustrated in FIG. 20, recognizing, for example, an object in an image can be accomplished by first extracting features from the image using an IM, such as, for example, that described above, and then classifying the object based on the extracted features using a classifier. A real-time classifier may be integrated with an IM to recognize objects from any number of classes, and in an illustrative embodiment, ten (10) classes. In an embodiment, a plurality, and in the embodiment illustrated in FIG. 21, four (4) sub-classifiers of classifier 26 are each coupled to the ring 20 of the neural network 12 of the IM. Each sub-classifier includes a number of class nodes (e.g., 10 class nodes) listening to the neuron spikes generated by neurons 14 of network 12. As described above, a neuron spike represents an active feature that triggers a weighted vote for each class node. The weight depends on the degree of the feature's association with the object class, and they are learned through supervised training. Since neuron spikes are sparse in the network 12, the classifier is designed to be event-driven to reduce its power, which, in at least some embodiments, may be on the order of an 80-90% reduction. Additionally, because the spikes generated by the neurons 14 of network 12 are binary spikes, the classifier 26 may be implemented using adders, replacing costly multipliers that are used in other classification systems. The use of adders has the benefits of reducing the cost of system 10 and also saving area (e.g., 60-75% savings) and reducing power consumption (e.g., 50-70% reduction). The class node outputs from the sub-classifiers are used to score the most likely object class as output.

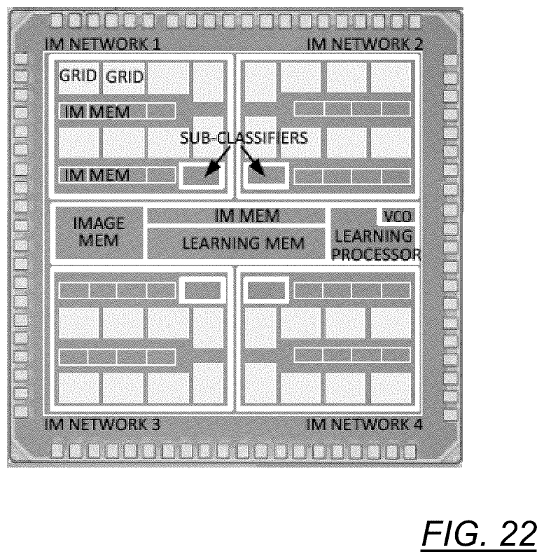

To demonstrate the operation and functionality of system 10 having both an IM and a classifier integrated thereon, a test chip was fabricated in TSMC 65 nm CMOS technology and bench tested. FIG. 22 depicts a microphotograph of the test chip with certain parts of the design highlighted. The test chip runs at a maximum frequency of 635 MHz at 1.0V and room temperature to achieve a high throughput of 10.16 Gpixel/s, dissipating 268 mW. The results demonstrate 8.2× higher throughput and 6.7× better energy efficiency than other previously fabricated ASICs. Tested with the MNIST database of 28×28 handwritten digits, the chip was able to recognize 9.9M objects/s at an accuracy of 84%. Increasing the inference period from 2t to 12t improved the classification accuracy to 90%, but cut the throughput by 6×.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Further, the term “electrically connected” and the variations thereof is intended to encompass both wireless electrical connections and electrical connections made via one or more wires, cables, or conductors (wired connections). Other terms are to be construed using their broadest reasonable meaning unless they are used in a context that requires a different interpretation.

1. A sparse coding system, comprising:
a neural network including a plurality of physical neurons each having a respective feature associated therewith and each being configured to be electrically connected to every other physical neuron in the network and to a portion of an input dataset,
wherein the plurality of physical neurons are arranged in a plurality of neuron clusters each comprising a different subset of two or more of the plurality of physical neurons, and further wherein the two or more physical neurons in each cluster are electrically connected to one another in a bus structure via one or more electrical conductors, and the plurality of clusters are electrically connected together in a ring structure, and
wherein the neural network is configured to perform a learning operation that includes, in response to one or more input images, recording in a memory, spike counts for a first group of the plurality of physical neurons that spike in response to the input image(s) before any of the other of the plurality of physical neurons spike in response to the input image(s), wherein the first group of the plurality of physical neurons comprises a number of the physical neurons that is less than the total number of the physical neurons in the neural network that spike in response to the input image(s), and updating one or more learning parameters for one or more of the plurality of physical neurons based on stored spike counts from only the physical neurons in the first group of neurons.

2. The system of claim 1, wherein the bus structure is a multi-dimensional bus structure comprising a plurality of rows, a plurality of columns, and a plurality of logic OR gates, wherein each OR gate is associated with a respective row or column and electrically connects the neurons in that row or column to one another.

3. The system of claim 1, wherein the bus structure is a multi-dimensional bus structure having A rows and B columns of neurons, and further wherein the bus structure comprises A horizontal buses each connecting B neurons in a respective row of the bus structure, and B vertical buses each connecting A neurons in a respective column of the bus structure.

4. The system of claim 1, further comprising a memory, and wherein each connection between two neurons has a respective weight W associated therewith and each connection between a neuron and at least a portion of the input dataset has a respective weight Q associated therewith, and further wherein each weight Q and W is stored in the memory of the system.

5. The system of claim 4, wherein the weights Q and W are quantized to a fixed-point number to reduce memory storage.

6. The system of claim 4, wherein the memory is partitioned into a first portion and a second portion, and further wherein both the first and second portions are used during a learning operation performed by the system, and only one of the first and second portions is used during an inference operation performed by the system.

7. The system of claim 6, wherein the first portion of the memory comprises the most significant bits (MSBs) of the Q and W weights, and the second portion of the memory comprises the least significant bits (LSBs) of the Q and W weights.

8. The system of claim 1, wherein parameter updates during the learning operation are passed to one or more neurons using a message passing approach.

9. The system of claim 1, wherein each neuron is configured to generate a binary spike output.

10. The system of claim 1, the neural network comprises a feature extractor inference module configured to extract features from an image represented by the input dataset, wherein the image contains an object.

11. The system of claim 10, further comprising an object classifier configured to classify the object in the input image based on the extracted features.

12. The system of claim 1, further comprising a power supply, and wherein a supply voltage supplied by the power supply to the neural network is scaled to take advantage of the error resilience of the sparse coding system.

13. A sparse coding system, comprising:
a sparse feature extractor inference module configured to extract features from one or more input images, each containing at least one object, wherein the inference module comprises an implementation of a sparse coding algorithm; and
an event-driven object classifier configured to classify the object in the input image(s) based on the extracted features,
wherein the sparse feature extractor inference module and event-driven object classifier are integrated on a single chip,
and further wherein the inference module comprises at least one neural network comprising a plurality of physical neurons each having a respective feature associated therewith and each being configured to be connected to every other physical neuron in the network and to at least a portion of the input image(s) when received; the neural network being configured to perform a learning operation that includes, in response to the input image(s), recording in a memory, spike counts for a first group of the plurality of physical neurons that spike in response to the input image(s) before any of the other of the plurality of physical neurons spike in response to the input image(s), wherein the first group of the plurality of physical neurons comprises a number of the physical neurons that is less than the total number of the physical neurons in the neural network that spike in response to the input image(s), and updating one or more learning parameters for one or more of the plurality of physical neurons based on stored spike counts from only the physical neurons in the first group of neurons.

14. The system of claim 13, wherein the at least one neural network has a scalable multi-layer architecture.

15. The system of claim 14, wherein the at least one neural network comprises a plurality of neuron clusters each comprising a respective subset of two or more of the plurality of physical neurons, and further wherein the two or more physical neurons in each cluster are electrically connected to one another in a bus structure via one or more electrical conductors, and the plurality of clusters are electrically connected together in a ring structure.

16. The system of claim 15, wherein the bus structure is a multi-dimensional bus structure comprising a plurality of rows, a plurality of columns, and a plurality of logic OR gates, wherein each OR gate is associated with a respective row or column and electrically connects the neurons in that row or column to one another.

17. The system of claim 13, wherein the inference module further comprises a memory, and wherein each connection between two neurons in the neural network has a respective weight W associated therewith and each connection between a neuron in the neural network and at least a portion of the input image has a respective weight Q associated therewith, and further wherein each weight W and Q is stored in the memory.

18. The system of claim 17, wherein the memory is partitioned into a first portion and a second portion, and further wherein both the first and second portions are used during a learning operation performed by the inference module and only one of the first and second portions is used during an inference operation performed by the inference module.

19. The system of claim 13, wherein the classifier comprises one or more adders and does not comprise any multipliers.

20. An object recognition system comprising the system of claim 13, wherein the inference module comprises a front-end of the object recognition system and the classifier comprises a back-end of the object recognition system.
